(19) United States
(12) Patent Application Publication
(10) Pub. No.: US 2006/0111977 A1
(43) Pub. Date: May 25, 2006

(54) Process for creating and disseminating marketing initiatives to specific consumers or specific consumer groups

(76) Inventor: Gary E. Hawkins, Syracuse, NY (US)

Correspondence Address: PEPPER HAMILTON LLP, ONE MELLON CENTER, 50TH FLOOR, 500 GRANT STREET, PITTSBURGH, PA, 15219, US

(21) Appl. No.: 11/283,202

(22) Filed: Nov. 18, 2005

Related U.S. Application Data
(60) Provisional application No. 60/629,475, filed on Nov. 19, 2004.
(60) Provisional application No. 60/662,773, filed on Mar. 17, 2005.

(51) Int. Cl. G06Q 30/00

(52) U.S. Cl. 705/14

(57) ABSTRACT

The present disclosure relates to a process for creating and disseminating retailer product offers to consumers. The process combines both store or retailer loyalty and product loyalty to identify, and market, to specific consumers and consumer groups. This may lead to less consolidation and a decrease in marketing and advertising costs, while creating an increase in profit for the retail industry.

### RELATED APPLICATION AND CLAIM OF PRIORITY

This application claims the benefit and priority of U.S. Provisional Application No. 60/629,475, filed Nov. 19, 2004, and U.S. Provisional Application No. 60/662,773, filed on Mar. 17, 2005, both of which are incorporated herein by reference in their entirety.

### BACKGROUND

The retail industry (manufacturers, distributors, and retailers) is under increasing pressure from forces within the industry and from external forces, such as increasing mass media advertising costs. Historical marketing and promotion practices based upon same-for-all price discounting are proving increasingly costly and less effective.

Forces within the mass retail industry are creating increasing pressure on manufacturers, distributors/wholesalers, and retailers. There is a tremendous amount of consolidation that has and continues to occur in the industry at the retail level. Competition has also led to an increase in channel blur, whereby retailers are selling products outside their traditional channel in search of increased sales. Manufacturers and retailers alike have been hard hit by the commoditization of branded goods and products.

In addition to these forces that are internal to the industry, there are external pressures in the marketing of goods throughout the supply chain. The cost of mass media advertising and marketing for manufacturers and retailers alike continues to increase significantly while providing less of a return. The increasing splintering of traditional mass media vehicles (i.e., going from three major television channels some years ago to hundreds today) means that the cost of reaching an equivalent audience size has substantially increased.

Historical trade promotion practices continue to increase in cost while providing less of a return on investment.

The advent of retail frequent shopper programs has provided the retail industry insight into true consumer shopping behavior. It has been determined that 30% of consumers generate approximately 75-80% of a retail company‘s’ annual sales with the bottom 30% of consumers (when ranked by spending) generating less than 3% of annual sales. Many retail companies also have tremendous churn occurring in their consumer base, losing a great many shoppers each year. Furthermore, it has been commonly found that retailers' regular patrons actually subsidize deals and loss-creating offers for more occasional, deal-seeking consumers.

Many of these same findings detailing vast differences in the shopping behavior and value of consumers have also been found at the brand level; i.e., a large portion of brands' sales and profits are derived from a minority of consumers purchasing the brand.

Concurrent with these developments in retail has been the growth and development of technologies supporting and enabling the cost-effective and time-effective communication and delivery of consumer specific marketing messages, information, and offers. Utilizing communication channels and devices such as, but not limited to, the Internet, email, kiosks in store, PDAs, cell phones, and direct mail, it is feasible and productive for the retail industry to go to market on a one-to-one basis rather than a same-for-all mass basis.

What is needed is a process that combines both store or retailer loyalty and product loyalty to identify, and market, to specific consumers and consumer groups. This would lead to less consolidation and a decrease in marketing and advertising costs, while creating an increase in profit for the retail industry. In addition, communication channels and devices that would be used with this process to allow it to operate successfully are also needed.

### SUMMARY

The present disclosure relates to a process for creating and disseminating retailer product offers to consumers. The process comprises collecting of consumer identification, information, and transaction data; storing the consumer information and transaction data in a database; determining from the consumer information and transaction data one or more offers to be extended to one or more consumers by an offeror; associating the one or more offers with the one or more consumers; and delivering the one or more offers to the one or more consumers via a communication network. The consumers then redeem the offer and redemption information is further provided to the offeror.

In an embodiment, a national advertising message may be delivered to the one or more consumers via the communication service. In another embodiment, a third party, such as an outside agency or advertising firm, may deliver the offer directly to the communication network. In an alternate embodiment, the one or more consumer offers may further comprise a consumer shopping list and a consumer reward program.

The consumer identification may be obtained through biometric information, loyalty and frequency shopper cards, cell phone data, and club membership information and the consumer information may comprise consumer shopping behavior and product loyalty. In addition, the transaction data may comprise store location or ID, date/time, UPC number for each item purchased, the quantity of each item purchased, the selling price of each item, discounts received (if applicable), payment method (cash, check, credit, debit, etc.), manufacturers coupons redeemed, applicable sales tax paid, total paid for the transaction, and the consumer identification code. The communication network comprises consumer e-mail, a consumer or retailer website, a retailer kiosk, or a mobile or cellular telephone.

In an embodiment, the process comprises collecting consumer identification, information, and transaction data; storing the consumer information and transaction data via a database; determining from the consumer information and transaction data one or more offers to be extended to one or more consumers by an offeror; associating the one or more offers with the one or more consumers; delivering the one or more offers to the one or more consumers and an offer delivery manager system via a communication network wherein the offer is held in the offer delivery manager system in an inactive state; and viewing of the consumer offer by the consumer via a communication network or service, wherein the offer is activated in the offer delivery system upon viewing of the offer by the consumer. The consumer may receive the offer automatically at the offeror upon consumer identification and a qualifying purchase. The consumer may then redeem the consumer offer and redemption information may further be provided to the offeror.

### BRIEF DESCRIPTION OF THE DRAWINGS

The accompanying drawings, which are incorporated in and form a part of the specification, illustrate various embodiments and, together with the description, serve to explain the principles of the various embodiments.

FIG. 1. is a flow chart according to an embodiment of the present invention.

FIG. 2 shows a representation of the type of benchmarking report that can be generated by the process for the retail company.

### DETAILED DESCRIPTION

Before the present embodiments, methods, and materials are described, it is to be understood that this disclosure is not limited to the particular embodiments, methodologies, and materials described, as these may vary. It is also to be understood that the terminology used in the description is for the purpose of describing the particular embodiments only, and is not intended to limit the scope.

It must also be noted that as used herein and in the appended claims, the singular forms “a,” “an,” and “the” include plural references unless the context clearly dictates otherwise. Unless defined otherwise herein, all technical and scientific terms used herein have the same meanings as commonly understood by one of ordinary skill in the art. All publications mentioned herein are incorporated by reference. Nothing herein is to be construed as an admission that the embodiments disclosed herein are not entitled to antedate such disclosure by virtue of prior invention.

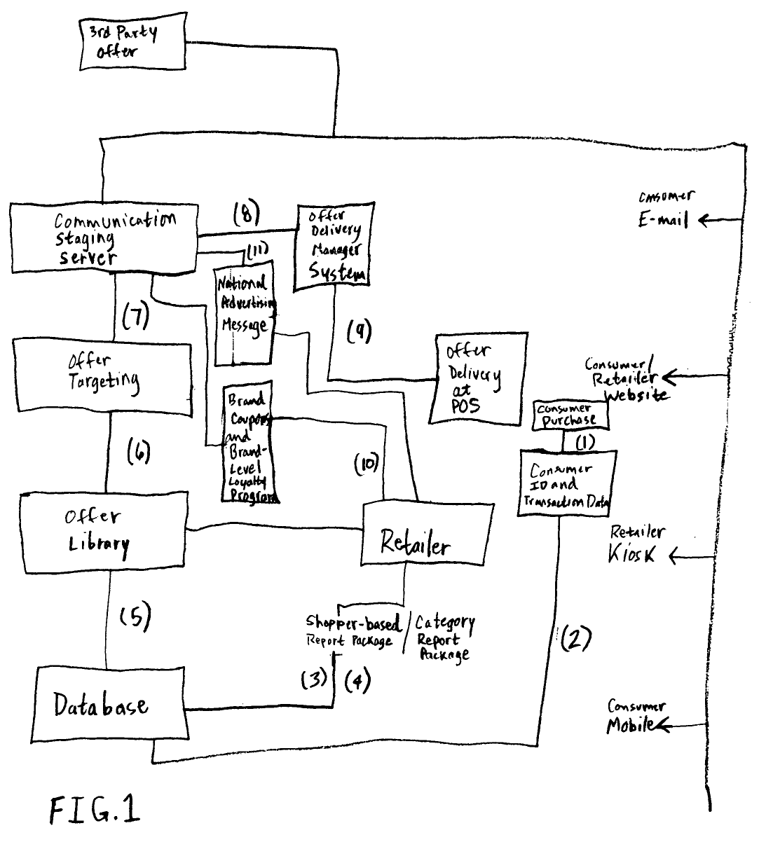

Referring to FIG. 1, a consumer of a retailer may be identified by the retailer when a purchase is made (Step 1). The retailer may obtain consumer specific identification through biometric information, loyalty and frequent shopper cards, cell phone data, or other club membership information to identify the consumer. Biometric information may also be used. Biometric information, such as fingerprints, may allow a retailer to quickly identify a consumer even if the consumer fails to provide a more traditional means of identification such as loyalty and frequent shopper cards, or club membership information. An example of biometric information is found in U.S. Pat. No. 6,012,039, the disclosure of which is incorporated herein by reference in its entirety. Consumers are encouraged to provide a form of identification discussed above to the retailer in return for some benefit including discounts, free merchandise, etc. The consumer identification is then appended to the transaction record. The purpose of such consumer identification is to allow the gathering of information over time, which may provide a detailed view of the consumers information, such as shopping behavior and product loyalty. It should be noted that the consumer identification through biometrics, loyalty shopper cards, etc. is collected first and that identification is then associated with the shopping behavior of the consumer.

Once the consumer is identified, the retail store may associate the consumers' transaction data with the consumers' contact information such as membership number, address, phone number, email, and demographic information. Other information may also be used. Such information preferably remains confidential to the retail store.

Transaction data may include store location or ID, data/time, UPC number for each item purchased, the quantity of each item purchased, the selling price of each item, discounts received (if applicable), payment method (cash, check, credit, debit, etc.), manufacturers coupons redeemed, applicable sales tax paid, total paid for the transaction, and the consumer identification code.

The consumer identification and transaction data that is collected by the retailer may be transferred for storage in a database (Step 2) either via a real time continuous connection or in periodic (i.e., each day) batches. The database may be an electronic database stored in an electronic medium such as a computer. The database may also be computer software or web enabled for access via a computer network or the Internet. The consumer identification and transaction data may be transferred in the form of an electronic journal, which is an electronic representation of the consumers' receipt showing the transaction data as discussed above. Information transferred to the data center may also include the retailers' product hierarchy, which provides their organization of products into categories and departments. If available, and if desired, the retail company can also transfer their product cost files so as to determine consumer profitability based upon actual purchases.

In return for providing the transaction level data to the database, the retail company may receive in exchange a set of reports detailing consumer value and shopping behavior (Step 3).

Such reports state measures of consumer retention, provide a consumer inventory (number of consumers within different segments), consumer segmentations relating to retailer sales, benchmark comparisons with other stores within the company, levels of consumer identification, etc. These reports reflect total company measures, division or region measures, and individual store measures. These reports may be used by the store or retailer to determine one or more offers to be extended to one or more consumers.

In cases where a retail company may produce some type of similar report, being a part of the database may allow the retail company to outsource such work, providing for the redirection of labor to other work or to provide cost savings.

This reporting may be web-enabled. In other words, the retailer, and all authorized personnel, may be able to view such reports over the Internet by using a web browser. However, the reporting may be received via other methods.

Most larger retail companies have in place a practice referred to as product category management, often supported by an organizational component. This practice commonly organizes similar products into categories with a person within the retail organization responsible for the sales and profits of a certain category. This person is responsible for periodically negotiating with the vendors or brokers of products within his or her category, discussing purchases, product cost, marketing initiatives, and so on.

This product category management structure is supported by coding each individual product to a specific department, sub-department, category, section, or some other organizational identification. This coding typically is part of a retail companies' master item file in which it maintains all relevant attributes of each individual product it sells (example, product vendor, UPC number, unit cost, selling price, sales tax coding, etc.).

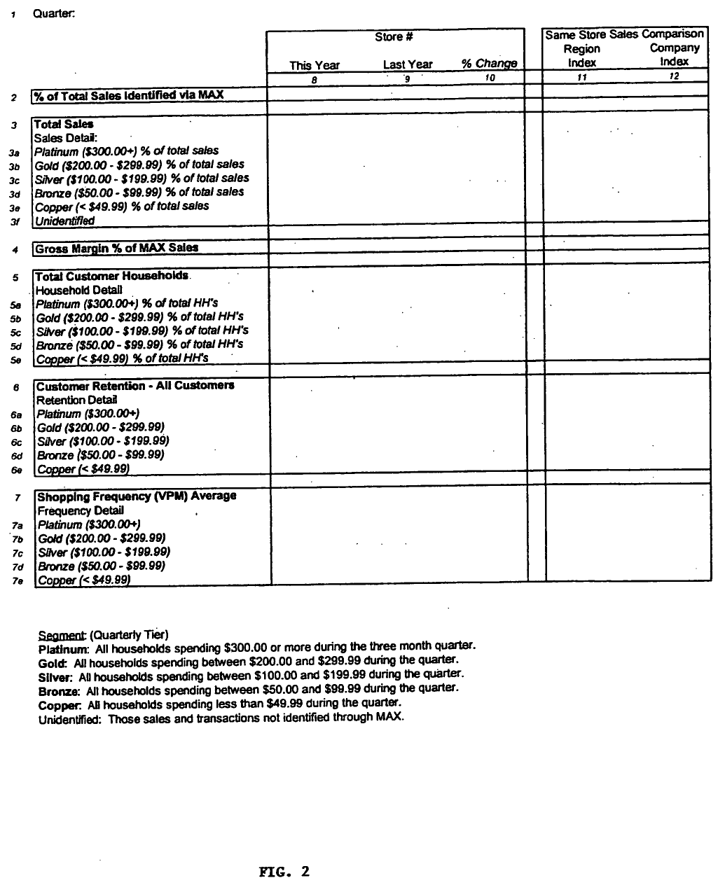

As an additional part of the value exchange associated with the retailer participating in the process, a set of reports and analysis, which are represented in FIG. 2 and are discussed in detail later, may be provided to the retailer on a regular basis (i.e., weekly, monthly, quarterly, etc.) that integrate category sales and unit movement with consumers; for example, viewing category sales across different consumer segments (Step 4).

Each cell in the analysis matrix of FIG. 1 may represent a consumer segment (i.e., Gold consumers that purchase in the Snacks category). Ultimately, different offers or marketing initiatives may be appended to these different consumer segments with the goal of seeking to maximize consumer lifetime value and loyalty.

Manufacturer participants of the process may have authorized access to these same reports (product and consumer category management) for their respective categories and products.

Such analysis and consumer segmentation may be utilized in vendor/retailer negotiations, enabling the two partners to negotiate various offers and marketing initiatives on a consumer segment basis.

The retail company may then load into the offer library all products on which it would like to extend special pricing (deal) to its consumers (Step 5). These products may be consumer goods, perishable products, private label products or any products/services the retailer offers. These products then serve as the library of offers which may then be targeted to specific consumers based upon certain business rules. The business rules are established by the retail company, sometimes in conjunction with their vendors or with the appropriate technology company that may be assisting the targeting process. The offer library may be a web-based service wherein the offeror (i.e., store, retailer, vendor, or manufacturer) may load the products into the offer library via the Internet by using a web browser. The offer library may also be software-enabled for loading of the products via a computer network.

It is expected that some retailers may have an existing consumer database segment based upon some methodology. The retail company may have the capacity to load these consumer segments into the offer library for purposes of targeting certain offers to specified consumer segments.

Vendors selling to the retail company may have the ability to load various product offers into the offer library, either directly with the retailers approval, or as the result of a negotiation process with the retail company. Alternatively, the vendor may load various product offers into the offer library to then be discussed and negotiated with the retail company as to the final offer pricing and/or targeting to specific consumer segments.

These offers from vendors may be a mix of national offers (the same “offer” made to everyone) or offers resulting from collaboration and negotiation between the vendor's consumer team and the retail company.

Each individual offer entered into the offer library may also have appropriate graphical images appended to it for purposes of marketing communications sent to the consumer. These graphical images are often representations of the product being offered (i.e., a graphical image of Tide laundry detergent will accompany an offer for Tide), and are commonly associated with the offer communication as delivered through websites, email, kiosks, or other communications (including direct mail). The appropriate graphical images may be sourced from third party providers, directly from the product manufacturer, through agencies, or other sources.

All offers available for the appropriate promotion cycle may be made available to the targeting engine at an appropriate time (Step 6). The targeting engine associates the offers with the consumers and may assign a specified number of specific offers to each individual consumer or consumer household. The targeting process is based upon certain business rules as established from time to time by the retail company. These business rules may also be established in conjunction with vendors, third party agencies, or with the technology company providing the targeting services.

The output from the targeting engine, a file containing consumer or consumer household identification and associated offer identification codes, is then transferred to the communication staging server in preparation for communication to the consumer (Step 7). The primary role of the communication staging server, in conjunction with the offer library, is to ensure coordination of communication across all communication channels or mediums, i.e., the same offer information is provided via a personal webpage as at the kiosk in the store.

The communication staging server may maintain and coordinate all information to be communicated to consumers relative to targeted and/or personalized offers. This information is then made available to the various communication networks or channels (email, personal webpage, kiosks, etc.) or is transferred to these services for communication to the individual consumer or consumer household. Other communication channels, such as regular mail or fax, are possible.

It is expected that the consumer or consumer household will interact with the retailers' website for purposes of obtaining targeted and personalized offers and other services. It is foreseen that the consumer may have the ability to register for email notification of special offers and/or other services. It is also foreseen that the consumer may be able to maintain other information such as name changes, address, phone numbers, or email address through the retailers' website. Such retailers' websites may be maintained by the retailer or outsourced to a third party.

One of the services a retailer may wish to offer consumers is the ability to create and maintain web-based shopping lists. As a further service, the retailer may wish to provide the ability for the consumer to access and print their shopping list in-store through a kiosk. This capability will be executed by the transferring of the shopping list to the communication staging server where it will be made available to the kiosk system. The active shopping list the consumer creates is exported to the communication and staging server in real time so it is available at the kiosk in-store. The consumer only needs to identify themselves at the kiosk in order for the shopping list and specials to begin printing. All other personal information created or maintained by the consumer through the website (address, phone, etc.) is transferred to the retailers' consumer database.

While online, the consumer may have the ability to add or modify personal information about themselves, such as address, email, or interests. This information is then sent back through to the consumer database of the retailer.

The communication staging server may periodically export or make available to an offer delivery manager system all pertinent offer information (UPC number, savings, limits, etc.) and a file containing all consumer identification codes and associated offer codes (which consumers qualify for which offers) (Step 8).

The offer delivery manager may then hold all offers for a given promotional period in an “inactive” status until such time as a consumer views their specific offers via one of the communication channels. For example, when a consumer views their consumer specific offers via the kiosk in the store, a message may be sent through the communication server and/or directly to the offer delivery manager. Upon receiving the message, the offer delivery manager “activates” the offers, enabling the consumer to receive the offer (savings, etc.) automatically at the point of sale (POS) based upon the consumer identification and a qualifying purchase. At the POS, offers that are made live in the offer delivery manager are delivered (Step 9). Purchases over time are also tallied and delivered when appropriate.

The retailer may decide to offer certain reward programs to its consumers, promising some gift or value in exchange for certain purchasing behavior over time, i.e., providing a $25 gift certificate to any consumer/household spending $500 in a specified 10 week period. Such programs may involve reporting back to the consumer their level of spending, or points balance, periodically. Such information may also be sent from the retailers' consumer database system to the communication staging server for communication out to the consumer via personal webpage and/or kiosks in the store (Step 10).

National advertising messages to be communicated to the consumer via the channels (email, personal webpage, kiosk, etc.) may be delivered to the communication staging server for communication out through the relevant channels (Step 11). For example, a consumer with a history of purchasing gourmet food items may receive an advertising message from Williams and Sonoma (a retailer offering gourmet cooking products). Such messages are staged through the communication staging server.

Alternatively, there may be occasion where such marketing communications or advertising may be delivered directly to the e-mail service, web provider, or kiosk by an outside agency or advertising firm.

The retailer has final approval of all communications made to their consumers. They have the ability to change, or adjust communications if they so choose.

It is at this point that the consumers' name and/or e-mail address is attached to the consumer identification code for communicating to the consumer through the available channels. For example, when the consumer goes to the kiosk in-store and identifies themselves (through loyalty card, biometric, etc.), the consumers' name and associated offers and/or reward status is displayed and/or printed. This process is used to ensure the confidentiality of the consumers' personal information (name, address, phone, email, etc.).

If a consumer has opted in for email service, for example wishing to have their personalized offers emailed to them periodically, the consumers' email address and associated offer information and any other applicable marketing or advertising content, is made available to the e-mail service provider. Such information is sent via a file to the email service and/or the file is made available at the communication staging server for the e-mail service provider to obtain. The e-mail service provider is then responsible for delivering the appropriate content to the individual consumer.

Communication staging supports the retailers' website (in-house or outsourced). The same offers and information may be available here that is in the e-mail or other digital channel. It is important to maintain all communications through the communications staging server to keep synchrony in the communications. The communication staging server may be device agnostic, which means that any new device that consumers wish to use can be supported. For example, consumers may wish to have certain information available to them via their cell phones. The communication staging server can provide information so as to be delivered over most any digital device. In addition, communication staging server supports the kiosk network in-store.

Offer analysis reporting is made available to vendors and to the retail companies to see the effectiveness of offers and to enable determination of a return on its investment. Over time offers can be refined and models built to effectively apply process improvement to marketing. The offer delivery manager provides for electronic settlement, thereby giving the retailer and vendor all necessary redemption information. In-store national advertising is communicated out through the kiosk network in-store, as well as any video displays- in-aisle or elsewhere. The target offering, communication staging server, and offer delivery manager system may be computer software driven or web-enabled for transfer of the information between each step via the network or the Internet.

FIG. 2 shows a representative of the type of benchmarking report that can be generated by the process for the retail company as part of the shopper report package.

In order to provide a summary of both traditional financial measures and consumer-based measures for the quarter, allowing the individual store to see their performance in the current year against the same quarter prior year, and to provide an index for comparing store performance to other stores in the region and to the total company store average, a benchmarking report may be issued to retailers on a regular basis (FIG. 1, Steps 3 and 4)

For the purposes of this invention, FIG. 2 provides for reports on a quarterly basis. Consumer households are segmented based upon their spending during the three-month quarter. All other attributes being reported (i.e., shopping frequency) flow from this initial segmentation based on spending.

The segments, which are in quarters, identify consumer households as platinum, gold, silver, bronze, and copper. Platinium refers to households who spend $300.00 or more during the three month quarter, gold refers to households who spend between $200.00 and $299.99 during the quarter, silver refers to households who spends between $100.00 and $199.99 during the quarter, bronze refers to households who spend between $50.00 and $99.99 during the quarter, copper refers to households who spend less than $49.99 during the quarter, and unidentified refers to those sales and transactions not identified through the disclosed process.

Line 2 represents the percentage of total sales identified through the disclosed process during the reporting quarter.

Line 3 represents the individual store total sales during the quarter. Lines 3a-3f detail sales generated by each household segment in that quarter during both the current and prior year. The results are expressed as percentage (%) of total sales. The percent (%) change in total sales between the two years is also reflected as % change. In addition, a comparison is made via an index between average regional store sales and total company store sales.

Line 4 represents the gross margin realized by a retailer during the current reporting quarter as compared to the same quarter during the prior year. A comparison is also made, via an index, between the regional and total company.

Line 5 represents the specific number of total households shopping with a retailer during a particular quarter. The results are expressed as a number. Lines 5a-5e reflect the percent (%) change in total number between the current quarter and the same quarter in the prior year. In addition, the same calculation is done for the regional store groups and total company to arrive at an index comparison.

Line 6 and, specifically lines 6a-6e, show the number of those consumers shopping with the store in the same quarter prior year that continue to shop with the store in the same quarter during the current year. (Same calculation is done for the regional store groups and total company to arrive at an index comparison.) Consumer retention is expressed as a percentage. For example, if 1,000 consumers shopped in quarter 2, year 1, of them, 650 shopped in quarter 2 of year 2. The store is retaining 65% of consumers annually.

Line 7 and, specifically lines 7a-7e, represent the shopping frequency that is arrived at by dividing the total number of transactions generated by a segment during the quarter by the total number of active consumers. For example, the shopping frequency of the platinum consumer segment is derived by dividing the number of transactions generated by platinum consumers during the reporting quarter by the number of platinum households. This total is compared to the same quarter in the prior year. In addition, a comparison is made between the regional and total company via an index.

The purpose of using an index is to provide the individual store management an easily understood reference point, allowing the store manager to see how their store compares to the average of other stores in their region and to the total company average. The index method used here is based upon using 100 as the base point (the results of the stores being the same as the average of the region or total company). Store results above or below region or company averages are reported as numbers greater than or less than 100. For example, if the total sales for an individual store were 20% less than the region average, the number being stated in the region index column for total sales would be 80 (100−20).

The regional index is derived by calculating the average of the metric being reported for all stores within the specified region. For example, the total number of households is measured for all the stores in the Ontario region. This number is then divided by the number of stores in the region for a per-store average. This average is then compared to the number of households for the individual store being reported. The result being expressed in terms of an index, using a base of 100. To continue the example, if the individual store has 10,000 total households in the quarter and the region average is 12,300, the number being expressed in the Region Index column would be 81.3 (10,000−12,300)/12,300=−18.7%. Expressed as an index, the results would be 100−18.7=81.3. The total company index is derived in the same fashion as the region index, but uses averages derived from the total number of stores open for each attribute being reported.

It will be appreciated that various of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art that are also intended to be encompassed by the following claims.

What is claimed is:

1. A process for creating and disseminating product offers to consumers comprising:
collecting consumer identification, information, and transaction data;
storing the consumer information and transaction data;
determining from the consumer information and transaction data one or more offers to be extended to one or more consumers by an offeror;
associating the one or more offers with the one or more consumers;
delivering the one or more offers to the one or more consumers via a communication network.

2. The process of claim 1 further comprising redemption of the offer by the consumer and providing redemption information to the offeror.

3. The process of claim 1 further comprising delivering a national advertising message to the consumer via the communication network.

4. The process of claim 1 further comprising a third party delivering the offer directly to the communication network.

5. The process of claim 4 wherein the third party comprises an outside agency or advertising firm.

6. The process of claim 1 wherein the consumer information and transaction data are stored in a database.

7. The process of claim 1 wherein the communication network comprises e-mail, website, kiosk, or mobile phone.

8. The process of claim 1 wherein consumer identification is obtained through biometric information, loyalty and frequency shopper cards, cell phone data, and club membership information and consumer information comprises shopping behavior and product loyalty information.

9. The process of claim 1 wherein the transaction data comprises store location or ID, date/time, UPC number for each item purchased, the quantity of each item purchased, the selling price of each item, discounts received, payment method, manufacturers coupons redeemed, applicable sales tax paid, total paid for the transaction, and the consumer identification code.

10. The process of claim 6 wherein the consumer information and transaction data is transferred to the database via a real time continuous connection or in periodic batches.

11. The process of claim 1 wherein the one or more offers comprise a graphical image.

12. The process of claim 1 wherein the one or more offers further comprise consumer shopping lists and consumer reward programs.

13. A process for creating and disseminating product offers to consumers comprising:
collecting consumer identification, information, and transaction data;
storing the consumer information and transaction data;
determining from the consumer information and transaction data one or more offers to be extended to one or more consumers by an offeror;
associating the one or more offers with the one or more consumers;
delivering the one or more offers to the one or more consumers and an offer delivery manager system via a communication network, the offer held in the offer delivery manager system in an inactive state;
viewing of the consumer offer by the consumer, wherein the offer is activated in the offer delivery system upon viewing of the offer by the consumer.

14. The process of claim 13 wherein the consumer receives the offer automatically at the offeror upon consumer identification and a qualifying purchase.

15. The process of claim 13 further comprising redemption of the offer by the consumer and providing redemption information to the offeror.

16. The process of claim 13 further comprising delivering a national advertising message to the consumer via the communication network.

17. The process of claim 13 further comprising a third party delivering the offer directly to the communication network.

18. The process of claim 17 wherein the third party comprises an outside agency or advertising firm.

19. The process of claim 13 wherein the consumer identification is obtained through biometric information, loyalty and frequency shopper cards, cell phone data, and club membership information and consumer information comprises shopping behavior and product loyalty information.

20. The process of claim 13 wherein the transaction data comprises store location or ID, date/time, UPC number for each item purchased, the quantity of each item purchased, the selling price of each item, discounts received, payment method, manufacturers coupons redeemed, applicable sales tax paid, total paid for the transaction, and the consumer identification code.

21. The process of claim 13 wherein the one or more offers comprises a graphical image.

22. The process of claim 13 wherein the communication network comprises consumer e-mail, a consumer or retailer website, and a retailer kiosk.

23. The process of claim 13 wherein the offer further comprises consumer shopping lists and consumer reward programs.

24. The process of claim 13 wherein the consumer information and transaction data are stored in a database.
